(19) United States
(12) Patent Application Publication
(10) Pub. No.: US 2016/0292976 A1
(43) Pub. Date: Oct. 6, 2016

(54) SECURITY LABEL

(71) Applicant: MAX-GEAR INNOVATIONS LIMITED, Hertfordshire (GB)

(72) Inventor: Richard NEWMAN, Hertfordshire (GB)

(73) Assignee: Rocket Building, Imperial Way, Watford, Hartfordshire (GB)

(21) Appl. No.: 15/038,371

(22) PCT Filed: Nov. 20, 2014
(86) PCT No.: PCT/GB2014/000481

§ 371 Date: May 20, 2016

(30) Foreign Application Priority Data
Nov. 20, 2013 (GB) 1320478.9

(51) Int. Cl. G08B 13/24; G09F 3/10; G09F 3/02

(52) U.S. Cl. CPC G08B 13/246; G09F 3/02; G09F 3/10; G08B 13/2434; G09F 2003/0201; G09F 2003/023; G09F 2003/0222; G09F 2003/0229

(57) ABSTRACT

A security label provided for the purpose of printing the price of an item on the label at the point at which the item price is calculated electronically. The label comprises a sticker having one face carrying an adhesive and an opposing face comprising a printable surface. The printable surface has a designated unprinted section within which a price for an item, once calculated, can be printed at the point of delivery of the item to a consumer. The adhesive surface having a security element attached thereto.

### FIELD OF INVENTION

The present invention relates to a security label. More especially the invention relates to a security label for perishable food purchased at a delicatessen counter of a retail outlet.

### BACKGROUND TO THE INVENTION

The majority of supermarkets in the UK and elsewhere include a delicatessen (“deli”) counter at which fresh perishable food items, such as meat and fish can be selected in any quantity by a customer for purchase.

Once the food has been chosen it is placed within a bag and weighed by a technician. A price label is applied to the bag.

The space surrounding a deli counter in, for example, a supermarket, is limited. This has not traditionally caused an issue as printing of the label is carried out using an industry standard, fairly compact, thermal printer located at the deli counter. Retailers traditionally use their own bespoke thermal printer to suit their chosen label and design.

Once obtained, the packaged food is to be added to other food items and paid for in the usual way at the supermarket checkout.

Unfortunately the procedure described above is not always followed by the consumer. A considerable problem faced by supermarkets is the theft of products obtained at the deli counter. Consumers who are inclined to steal find it fairly easy to hide deli counter items as they pass through the checkout, thereby avoiding paying for them. Since known deli counter price labels are simply printed stickers having no other security measure, the security gates are not activated on exit. Consequently it is fairly easy to steal food obtained at the deli counter as no alarms are activated at the point of exit. Moreover, the customer is unlikely to be suspected of stealing if they have been seen paying for (the rest of) their items at the checkout.

The present invention seeks to alleviate the problems with theft by providing a deli label which includes a security element and which is printed on at the point of delivery of the item to the customer at the deli counter.

The idea of providing a printed label with a security element attached to the label is known. U.S. Pat. No. 5,589,741 for example, discloses apparatus for attaching an electronic security tag to a freshly printed label. This patent discloses a system which is concerned with applying a security tag to a printed sticker prior to the sticker being placed on to packaging. The security tag is not applied to the label until after the label has been printed, which itself happens only after the food item has been weighed.

The apparatus is designed for use prior to the item being processed at a subsequent station (column 5 lines 5 to 15). The apparatus comprises large industrial machinery to able to apply the security tag to the label once it has been printed. The process for securing to security tag to the printed label is discussed at column 3 lines 43 to 60. The machinery for this part includes multiple elements including a semicircular guide, guide plate, stripper element and guide roller.

The present applicant has many years of experience in dealing with security tags for application to labels. They have found through extensive research and development that the security tag coil is inherently unstable up to the point at which it is adhered to a backing layer or label. As such, the process of applying the security tag to the label should be carried out in an industrial building where humidity can be carefully controlled.

All of the above means that the apparatus of U.S. Pat. No. 5,897,741 is not in any way suitable for location and use at a deli counter in a retail outlet.

Moreover, the apparatus of U.S. Pat. No. 5,897,741 would not be suitable for a deli counter because the weight and cost of the food item is not known until it, and the amount, is selected by the customer.

JPH3-153565 similarly discloses a weight label having an electric circuit to prevent theft. The patent discloses a weight label, printed with full details of the item (after the item has been identified and weighed) with an electronic circuit on the reverse. The label is not suitable for use at a deli counter as it is not printed at the point of delivery (the first time in which the foodstuff and weight can be identified).

Further disclosures of similar apparatus concerning labels with security tags are disclosed in US2007251521A, U.S. Pat. No. 5,614,278A, US2013228478A, CN203102330U, CN203689564U, CN103489241A, US2009276089A, US2007252700A and CN103778850A.

All the prior art identified relate to pre-printed labels with security tags. None of the documents are suitable for use at a deli counter where identification and weight of the food item is not known until the customer once they have made their selection.

### STATEMENT OF INVENTION

According to a first aspect of the invention there is provided a security label provided for the purpose of printing the price of an item on the label at the point at which the item price is calculated electronically, the label comprising a sticker having one face carrying an adhesive and an opposing face comprising a printable surface, the printable surface having a designated unprinted section within which a price for an item, once calculated, can be printed at the point of delivery of the item to a consumer, and the adhesive surface having a security element attached thereto.

Preferably the security element comprises a substrate carrying an RF coil winding which is de-activatable at the point of purchase.

Preferably, the front face of the substrate includes an adhesive such that the substrate and sticker can be adhered to the packaging.

Preferably the unprinted section of the printable surface does not overlie the RF coil attached to the other side of the label.

The entire printable surface of the label may be unprinted prior to the item being chosen by a consumer, all printing being carried out at the point at which the item and it's weight has been identified.

Preferably, a plurality of labels according to the first aspect are arranged on a reel for use within an existing printer located at the point at which the item for packaging is chosen.

According to a third aspect, there is provided a method of applying a security label to food packaging at the point of delivery to a consumer, the method comprising the steps of:
providing a security label comprising a printable face, at least a section of which is unprinted, and an opposing face that carries a security element and adhesive;
calculating the price of an item selected by the consumer; and
printing the calculated price on the blank section of the of the label face and applying the opposing face to the packaging of the selected item.

Preferably the label has at least one further unprinted section and the method includes the step of printing details identifying the item in the further unprinted section.

The printable face may be entirely blank wherein all printing on to the printable surface of the label is applied at the point of delivery of the item to the consumer.

Alternatively the printable surface may already be provided with some printed matter thereon (such as the company name or logo) but includes a blank section which receives the price information and product identification, printed at point of delivery of the item to the consumer.

Preferably a length of separable labels are provided on a backing strip in reel form. The reel can then be used with standard label printing devices currently used for printing price labels at deli counters.

Preferably the labels are square or rectangular.

### BRIEF DESCRIPTION OF THE DRAWINGS

One embodiment of the invention will now be described by way of example only, with reference to the accompanying figures in which:

FIG. 1 is a view of a printable face of the security label constructed in accordance with the invention;

FIG. 2 is a view of the opposing face of the security label of FIG. 1;

FIG. 3 is a view of the printable face of second example of a security label;

FIG. 4 is a view of the labels of FIG. 3 on a reel; and

FIG. 5 is a view of further example of a labels on a reel.

### DETAILED DESCRIPTION OF PREFERRED EMBODIMENTS

The invention relates to a security label 2 to be applied to fresh food packaging, typically given to the client at a deli counter within a supermarket.

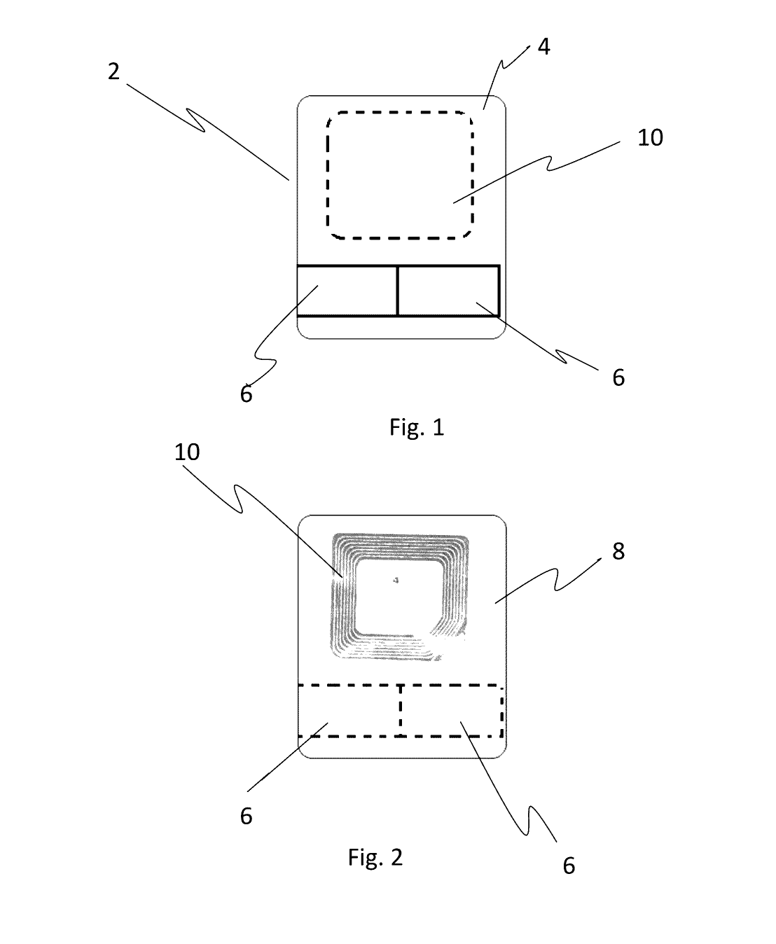

As can be seen in FIGS. 1 and 2, the label 2 is made of paper or similar material and is generally rectangular. It will be appreciated though that the label could be of any shape and size suitable for printing.

FIG. 1 shows one side face 4 of the label 2. This face 4 has a designated section 6 for printing. This section 6 is blank and unprinted and is positioned to receive a barcode which is only printed once the product, it's weight and price have been selected at the point of delivery of the item to customer at, for example, a delicatessen counter.

The face 4 has a further printable area 6, on which items details, such as its weight, price per weight and price can be printed, once they are available, which is again at the point of delivery to the customer. The printable area 6 may be blank or may have a pre-printed background colour or design. The label 2 shown in FIGS. 1 and 2 has two designated printing areas, one to receive a barcode and the second to receive the pricing information.

The label 2 has designated unprinted section must be blank initially as the relevant information is not known until the customer has made their selection at the counter. As such, the bar code and product price details can only printed in the designated sections after the selection has been made, i.e. at the point of delivery.

The opposing side face 8 of the label 2, shown in FIG. 2 carries an adhesive and has located thereon a security element 10. In this case the security element comprises a generally square substrate 12 carrying an RF coil 14. The RF coil 14 is deactivatable at the point of sale of the item. By “sale” is it meant the time at which the item is paid for (as opposed to the point at which the item is given to the consumer).

The relevant details (for the purpose of the invention) of the reverse face of the label 2 are shown in dashed lines in FIGS. 1 and 2.

The substrate 12 is adhered to the face 8 of the label 2. The outer face of the substrate 12 also carries an adhesive so that, once printed, the entire label face 8, including the security element, can be stuck to the food packaging, typically a bag. Once applied to the packaging security element 14 lies underneath the printed face 4 of the label 2, and so cannot be easily separated from, or scratched off, the label 2.

A length of individual or separable labels 2 are provided on a backing strip as a reel so that they can be used with the thermal printers already used by the retailer for the deli produce.

Each label 2 may be provided with a release liner (not shown) which overlays the face 8, including the security element 14, to be removed at the point at which the label 2 is applied to the packaging.

In order to print the barcode and item details including price by weight on the face 4 of the label, the label 2, including the security element, must be fed through the thermal printer provided to, or already in the possession of, the retailer. The added thickness of the label around the location of the security tag is problematic to this process. Should, for example, the printable area extend over the side of the security tag, a ridge is formed which may disrupt and/or obscure the print causing it not to be readable to electronic devices at the point of sale.

Furthermore, the coil and/or antenna of the security tag may be damaged during the printing process if it extends directly beneath the area which is printed.

It should be appreciated that any failure of the electronic devices to read the label at the point of sale can cause major issues to the overall running of the supermarket.

The Applicant undergoes extensive experimentation and testing to locate the optimum position and design of security tag for any specific label and/or thermal printer. In some cases, up to seventy positional variations have been tested to find the optimum locations and designs.

Although the tag is shown as generally rectangular or square in the figures, it will be appreciated that the tag could be made in any size, shape or design, for example the tag could be circular or semi-circular depending on the constraints on its location on the label.

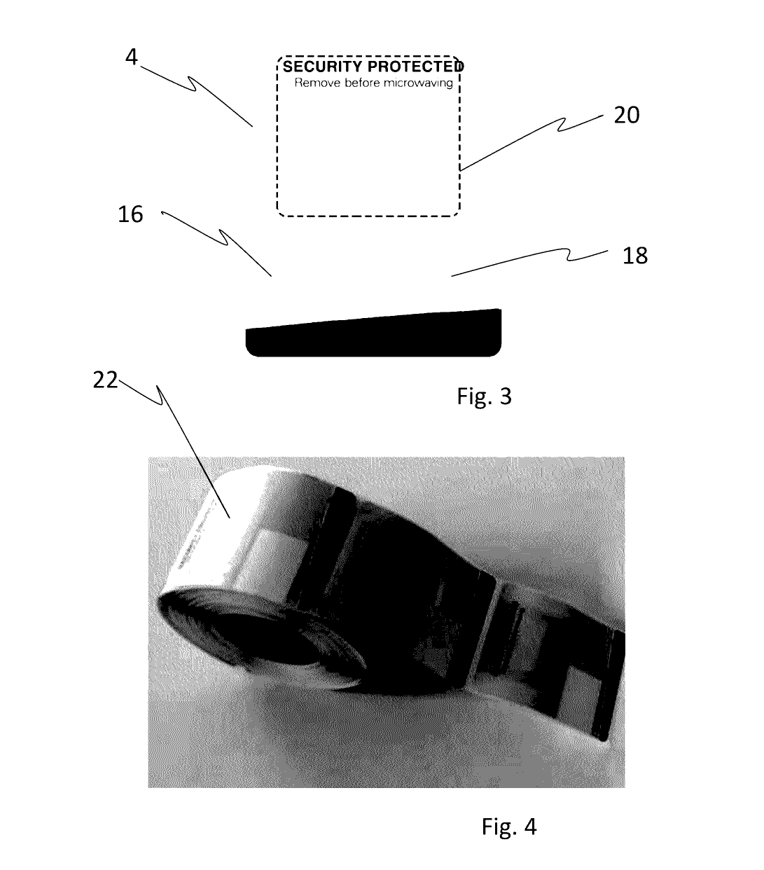

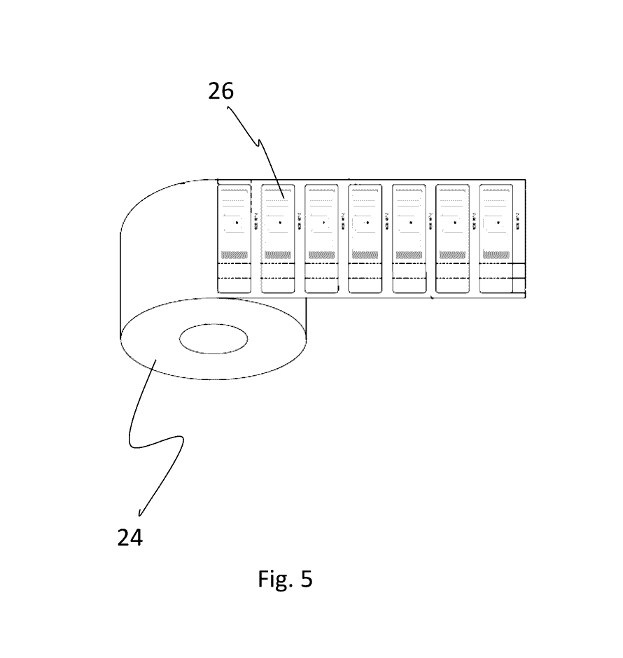

FIGS. 3 and 4 show a further example of a label 2 according to the invention.

In this example, a certain amount of background print is already provided on the face 4 of the label 2. Such printing indicia would, for example, include the retail outlet branding, instructions (regarding for example use in a microwave) or security warnings. The face 4 includes a blank un-printed section 16 within which a barcode can be printed and a further designated printable section 18 on which the item details, including weight and price can be printed. This may be blank or may have a pre-printed background colour or design. The security tag 20 on the reverse side 6 is shown is dashed lines. It can be seen that the area designated for printing 16, 18 does not overlie the security element thereby avoiding damage to the tag 20 or distortion of the print during the printing process.

FIG. 4 shows the labels provided on a reel 22 for installation into the existing thermal printer used for deli counter labels.

FIG. 5 shows a reel of labels 24, each incorporating an RFID tag 26. The reverse side of each label (not seen in the figure) is entirely blank or has at least a blank section to provide at least one designated area for printing as hereinbefore described.

The foregoing description refers to a price label for food selected at a deli counter. It is appreciated that the invention would have application at any counter within a retail outlet wherein the product is selected but not necessarily purchased at that time. For example, the invention could have application at chemist counters or the like.

1. A security label provided for the purpose of printing the price of an item on the label at the point at which the item price is calculated electronically, the label comprising a sticker having one face carrying an adhesive and an opposing face comprising a printable surface, the printable surface having a designated section within which a price for an item, once calculated, can be printed at the point of delivery of the item to a consumer, and the adhesive surface having a security element attached thereto.

2. The security label according to claim 1, wherein the label comprises at least one further designated unprinted section within which a barcode is printed at the point of delivery of the item to a consumer.

3. The security label according to claim 1, wherein the security element comprises an radio frequency (RF) coil which is de-activatable at the point of purchase.

4. The security label according to claim 1, further comprising a release liner covering the face with adhesive to be removed at the point at which the label is applied to the packaging.

5. The security label according to claim 1, wherein the RF coil is carried on a substrate.

6. The security label according to claim 5, wherein a front face of the substrate includes the adhesive such that the substrate and the sticker can be adhered to the packaging.

7. The security label according to claim 1, wherein the printable face is entirely blank such that all printing on to the printable surface of the label is applied, in use, at the point of delivery of the item to the consumer.

8. The security label according to claim 1, wherein the printable surface includes a blank section to receive the price information, printed, in use, at point of delivery of the item to the consumer.

9. The security label according to claim 1, wherein one or more of the security labels are arranged on a reel for use within an existing printer located at the point at which the item for packaging is chosen.

10. A method of applying a security label to food packaging at the point of delivery to a consumer, the method comprising the steps of:
providing the security label comprising a printable face, at least a section of which is blank, and an opposing face that carries a security element and adhesive;
calculating the price of an item selected by the consumer; and
printing the calculated price on the blank section of the of the label face and applying the opposing face to the packaging of the selected item.

11. The method according to claim 10, wherein the label has at least one further unprinted section and the method includes the step of printing details identifying the item in the further unprinted section.
